(19) United States
(12) Patent Application Publication
(10) Pub. No.: US 2026/0222701 A1
(43) Pub. Date: Jul. 30, 2026

(54) PHOTODETECTION DEVICE, IMAGING DEVICE AND ELECTRONIC EQUIPMENT

(71) Applicant: SONY SEMICONDUCTOR SOLUTIONS CORPORATION, KANAGAWA (JP)

(72) Inventor: YURI KATO, KANAGAWA (JP)

(21) Appl. No.: 19/142,990

(22) PCT Filed: Nov. 13, 2023
(86) PCT No.: PCT/JP2023/040680

§ 371 Date: Jun. 25, 2025

(30) Foreign Application Priority Data
Jan. 5, 2023 (JP) 2023-000389

(51) Int. Cl. H04N 25/62; H04N 25/47; H04N 25/77

(52) U.S. Cl. CPC H04N 25/62; H04N 25/47; H04N 25/77

(57) ABSTRACT

To improve detection accuracy of an event signal while enabling mixed mounting of gradation pixels and event pixels. A photodetection device includes: a gradation pixel that detects a gradation signal; an event pixel that detects an event signal; a light-shielded event pixel in which the event pixel is shielded from light; and a detection circuit that detects a false event output from the event pixel on the basis of an output from the light-shielded event pixel. A correction circuit that corrects a false event detected by the detection circuit may be further included. A notification circuit that notifies of a false event detected by the detection circuit may be further included.

### TECHNICAL FIELD

The present technology relates to a photodetection device, an imaging device, and electronic equipment. Specifically, the present technology relates to a photodetection device, an imaging device, and electronic equipment capable of detecting both a gradation signal and an event signal.

### BACKGROUND ART

In an imaging device, there is a technology in which gradation pixels that detect gradation signals and event pixels that detect event signals are mixedly mounted. For example, there has been proposed a sensor device that is capable of, in row sequence at different timings, executing selection of pixels from which event signals are to be read and selection of pixels from which gradation signals are to be read (For example, see Patent Document 1.).

### CITATION LIST

### Patent Document

Patent Document 1: Japanese Patent Application Laid-Open No. 2021-129265

### SUMMARY OF THE INVENTION

### Problems to be Solved by the Invention

However, in the above-described conventional technology, when a signal crosstalk occurs between a gradation pixel and an event pixel, there is a possibility that detection accuracy of an event signal or a gradation signal is deteriorated.

The present technology has been made in view of such a situation, and an object thereof is to improve detection accuracy of an event signal while enabling mixed mounting of gradation pixels and event pixels.

### Solutions to Problems

The present technology has been made to solve the above-described problems, and a first aspect thereof is a photodetection device including: a gradation pixel that detects a gradation signal; an event pixel that detects an event signal; a light-shielded event pixel in which the event pixel is shielded from light; and a detection circuit that detects a false event output from the event pixel on the basis of an output from the light-shielded event pixel. This brings about an effect of improving the detection accuracy of the event signal while enabling mixed mounting of the gradation pixel and the event pixel.

Furthermore, in the first aspect, a correction circuit that corrects a false event detected by the detection circuit may be further included. This brings about an effect of correcting the false event while enabling mixed mounting of the gradation pixel and the event pixel.

Furthermore, in the first aspect, the correction circuit may mask the event signal detected in the event pixel on the basis of a false event detected by the detection circuit. This brings about an effect of preventing an output of a false event while enabling mixed mounting of the gradation pixel and the event pixel.

Furthermore, in the first aspect, the correction circuit may interpolate the event signal detected in the event pixel with the event signal detected in an event pixel near the event pixel on the basis of a false event detected by the detection circuit. This brings about an effect of preventing an output of a false event while preventing a lack of the event signal.

Furthermore, in the first aspect, the correction circuit may spatially or temporally filter the event signal detected in the event pixel on the basis of a false event detected by the detection circuit. This brings about an effect of correcting the false event while enabling mixed mounting of the gradation pixel and the event pixel.

Furthermore, in the first aspect, a notification circuit that notifies of a false event detected by the detection circuit may be further included. This brings about an effect that the correction of the false event can be performed externally.

Furthermore, in the first aspect, the notification circuit may add information regarding a false event detected by the detection circuit to output data of an event image. This brings about an effect that the false event is notified along with the output of the event image.

Furthermore, in the first aspect, an effective pixel region in which pixels are arranged in a row direction and a column direction including the gradation pixel and the event pixel may be included. This brings about an effect that the gradation pixel and the event pixel are mixedly mounted in the effective pixel region.

Furthermore, in the first aspect, the gradation pixels may be arranged in the effective pixel region on the basis of a quad-Bayer array, and the event pixels may be arranged at positions of two red pixels out of four red pixels and positions of two blue pixels out of four blue pixels in the quad-Bayer array. This brings about an effect that the gradation pixels and the event pixels are mixedly mounted in the effective pixel region while suppressing a decrease in sensitivity of a colored gradation image.

Furthermore, in the first aspect, the light-shielded event pixel may be disposed at an end portion of the effective pixel region in the row direction. This brings about an effect that a false event is detected for each row.

Furthermore, in the first aspect, the detection circuit may detect a false event output from the event pixels arranged in the row direction on the basis of an output from the light-shielded event pixel. This brings about an effect that the false event output from the event pixels is detected for each row on the basis of the false event output for each row from the light-shielded event pixel.

Furthermore, in the first aspect, the detection circuit may detect a false event caused by crosstalk with a horizontal control line of the gradation pixel on the basis of an output from the light-shielded event pixel. This brings about an effect that the false event output from the event pixel is detected for each row on the basis of the false event caused by the crosstalk with the horizontal control line of the gradation pixel.

Furthermore, in the first aspect, the light-shielded event pixel may be disposed at an end portion of the effective pixel region in the column direction. This brings about an effect that a false event is detected for each column.

Furthermore, in the first aspect, the detection circuit may detect a false event output from the event pixels arranged in the column direction on the basis of an output from the light-shielded event pixel. This brings about an effect that the false event output from the event pixels is detected for each column on the basis of the false event output for each column from the light-shielded event pixel.

Furthermore, in the first aspect, the detection circuit may detect a false event caused by crosstalk with a vertical signal line of the gradation pixel on the basis of an output from the light-shielded event pixel. This brings about an effect that the false event output from the event pixel is detected for each column on the basis of the false event caused by the crosstalk with the vertical signal line of the gradation pixel.

Furthermore, in the first aspect, the light-shielded event pixel may be disposed in the effective pixel region. This brings about an effect that the light-shielded event pixel is disposed in the vicinity of the event pixel.

Furthermore, in the first aspect, the detection circuit may detect a false event output from an event pixel near the light-shielded event pixel on the basis of an output from the light-shielded event pixel. This brings about an effect that crosstalk similar to crosstalk of an event pixel occurs in a light-shielded event.

Furthermore, a second aspect is an imaging device including: an effective pixel region in which pixels are arranged in a row direction and a column direction including a gradation pixel that detects a gradation signal and an event pixel that detects an event signal; and a light-shielded event pixel that is provided in the effective pixel region and in which the event pixel is shielded from light. This brings about an effect that the light-shielded event pixel is disposed in the vicinity of the event pixel.

Furthermore, in the second aspect, the gradation pixels may be arranged in the effective pixel region on the basis of a quad-Bayer array, the event pixels may be arranged at positions of two red pixels out of four red pixels in the quad-Bayer array, and the light-shielded event pixels may be arranged at positions of two blue pixels out of four blue pixels in the quad-Bayer array. This brings about an effect that the light-shielded event pixels are arranged in the vicinity of the event pixels while suppressing a decrease in sensitivity of a colored gradation image.

Furthermore, a third aspect is electronic equipment including: a photodetection device including a gradation pixel that detects a gradation signal, an event pixel that detects an event signal, a light-shielded event pixel in which the event pixel is shielded from light, and a detection circuit that detects a false event output from the event pixel on the basis of an output from the light-shielded event pixel; and a processing section that processes the event signal on the basis of the false event detected by the detection circuit. This brings about an effect that a false event is corrected outside the photodetection device while enabling mixed mounting of the gradation pixel and the event pixel.

### BRIEF DESCRIPTION OF DRAWINGS

FIG. 1 is a block diagram illustrating a configuration example of an imaging device according to a first embodiment.

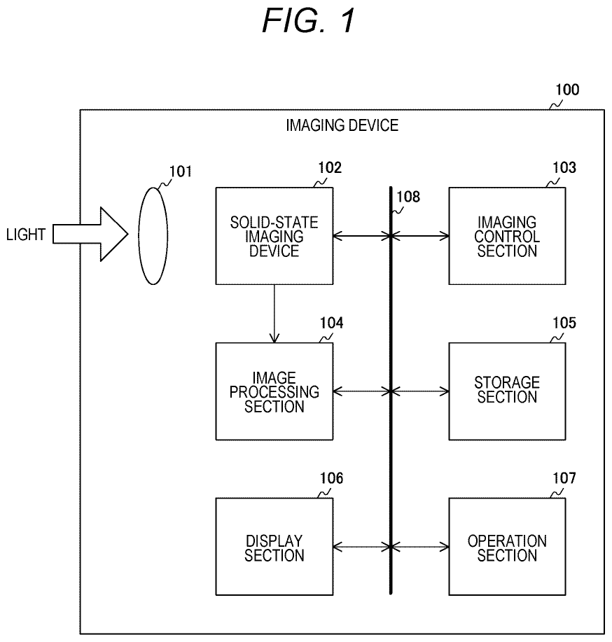

FIG. 2 is a block diagram illustrating a configuration example of a solid-state imaging device according to the first embodiment.

FIG. 3 is a block diagram illustrating a configuration example of a pixel array section according to the first embodiment.

FIG. 4 is a block diagram illustrating an arrangement example of pixels of the pixel array section according to the first embodiment.

FIG. 5 is a circuit diagram illustrating an example of signal crosstalk between a gradation pixel and an event pixel of the solid-state imaging device according to the first embodiment.

FIG. 6 is a diagram illustrating an example of a timing of signal crosstalk between the gradation pixel and the event pixel of the solid-state imaging device according to the first embodiment.

FIG. 7 is a flowchart illustrating an example of false event detection processing by the solid-state imaging device according to the first embodiment.

FIG. 8 is a block diagram illustrating a configuration example of a solid-state imaging device according to a second embodiment.

FIG. 9 is a flowchart illustrating an example of false event detection processing by the solid-state imaging device according to the second embodiment.

FIG. 10 is a block diagram illustrating a configuration example of a solid-state imaging device according to a third embodiment.

FIG. 11 is a block diagram illustrating a configuration example of a pixel array section according to a fourth embodiment.

FIG. 12 is a circuit diagram illustrating an example of signal crosstalk between a gradation pixel and an event pixel of a solid-state imaging device according to the fourth embodiment.

FIG. 13 is a block diagram illustrating a configuration example of a pixel array section according to a fifth embodiment.

FIG. 14 is a block diagram illustrating a configuration example of a pixel array section according to a sixth embodiment.

FIG. 15 is a block diagram illustrating an arrangement example of pixels of a pixel array section according to a seventh embodiment.

FIG. 16 is a perspective view illustrating a configuration example of pixels of a pixel array section according to an eighth embodiment.

FIG. 17 is a block diagram illustrating a schematic configuration example of a vehicle control system.

FIG. 18 is an explanatory diagram illustrating an example of an installation position of an imaging section.

### MODE FOR CARRYING OUT THE INVENTION

Modes for carrying out the present technology (hereinafter, referred to as embodiments) will be described hereinafter. The description will be given in the following order.

1. First embodiment (Example of detecting a false event output from an event pixel on the basis of an output from a light-shielded event pixel)

2. Second embodiment (Example of detecting and notifying of a false event output from an event pixel on the basis of an output from a light-shielded event pixel)

3. Third embodiment (Example of detecting and correcting a false event output from an event pixel on the basis of an output from a light-shielded event pixel)

4. Fourth embodiment (Example of providing a horizontal light-shielded pixel region in which light-shielded event pixels are arranged)

5. Fifth embodiment (Example of providing light-shielded event pixels in each of a vertical light-shielded pixel region and a horizontal light-shielded pixel region)

6. Sixth embodiment (Example of providing light-shielded event pixels in an effective pixel region)

7. Seventh embodiment (Example in which event pixels are provided at positions of red pixels in a quad-Bayer array and light-shielded event pixels are provided at positions of blue pixels in the quad-Bayer array)

8. Eighth embodiment (Example of stacking a pixel array section)

9. Application example to a mobile body

### 1. First Embodiment

In the drawing, an imaging device 100 includes an optical system 101, a solid-state imaging device 102, an imaging control section 103, an image processing section 104, a storage section 105, a display section 106, and an operation section 107. The imaging control section 103, the image processing section 104, the storage section 105, the display section 106, and the operation section 107 are connected to each other via a bus 108. Note that the imaging device 100 may be used alone, may be incorporated in a portable terminal such as a smartphone, or may be incorporated in an authentication device or a monitoring device.

The optical system 101 causes light from a subject to enter the solid-state imaging device 102, and forms an image of the subject on a light-receiving surface of the solid-state imaging device 102. The optical system 101 can include, for example, a focus lens, a zoom lens, a diaphragm, and the like. The optical system 101 may include a plurality of lenses such as a wide-angle lens, a standard lens, and a telephoto lens.

The solid-state imaging device 102 converts light from the subject into an electric signal for each pixel, and digitizes and outputs the electric signal. The solid-state imaging device 102 can output a gradation signal according to the luminance of the incident light and an event signal in which a change in the luminance of the incident light in the same direction is detected as an event. At this time, the solid-state imaging device 102 can be provided with a gradation pixel that detects a gradation signal, an event pixel that detects an event signal, and a light-shielded event pixel in which the event pixel is shielded from light. Then, the solid-state imaging device 102 can detect the false event output from the event pixel on the basis of the output from the light-shielded event pixel.

The imaging control section 103 controls the imaging by the solid-state imaging device 102 on the basis of a command from the operation section 107. At this time, the imaging control section 103 can control the exposure time, the exposure amount, the imaging timing, and the like of the solid-state imaging device 102.

The image processing section 104 performs image processing on the basis of the output from the solid-state imaging device 102. The image processing is, for example, gamma correction, white balance processing, sharpness processing, or gradation conversion processing. The image processing section 104 may include a processor that executes processing on the basis of software. The image processing section 104 may process an event detected by the solid-state imaging device 102 on the basis of a false event detected by the solid-state imaging device 102.

The storage section 105 stores a captured image captured by the solid-state imaging device 102, and stores imaging parameters and the like of the solid-state imaging device 102. The captured image may include a gradation image and an event image. Furthermore, the storage section 105 can store a program for operating the imaging device 100 on the basis of software. The storage section 105 may include a read only memory (ROM), a random access memory (RAM), and a memory card.

The display section 106 displays a captured image and displays various types of information supporting the imaging operation. The display section 106 may be a liquid crystal display or an organic electro luminescence (EL) display.

The operation section 107 provides a user interface for operating the imaging device 100. The operation section 107 may include, for example, a button, a dial, and a switch provided in the imaging device 100. The operation section 107 may include a touch panel configured together with the display section 106.

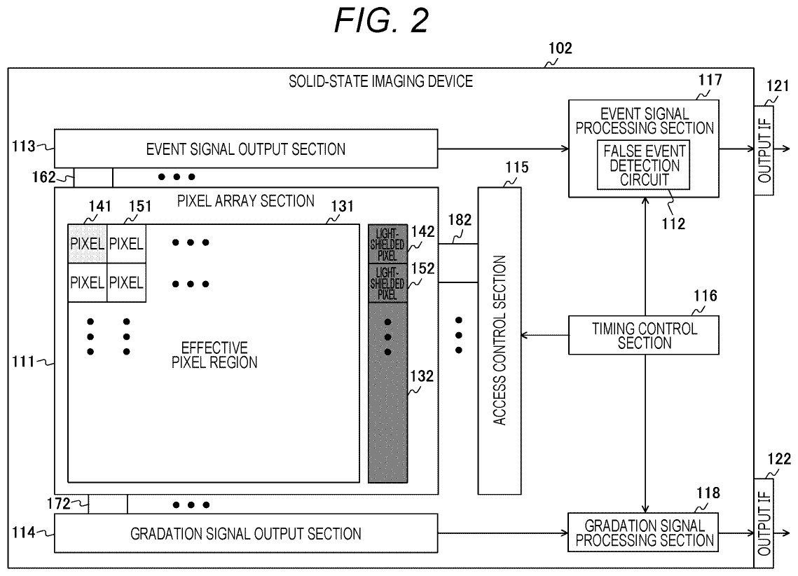

FIG. 2 is a block diagram illustrating a circuit configuration example of the solid-state imaging device according to the first embodiment.

In the drawing, the solid-state imaging device 102 includes a pixel array section 111, an event signal output section 113, a gradation signal output section 114, an access control section 115, a timing control section 116, an event signal processing section 117, and a gradation signal processing section 118. Output interfaces 121 and 122 are connected to the solid-state imaging device 102.

The pixel array section 111 includes an effective pixel region 131 in which incident light can be detected for each pixel and a light-shielded pixel region 132 in which the incident light is shielded for each pixel. In the effective pixel region 131, pixels are arranged in a matrix in a row direction and a column direction. The pixels arranged in the effective pixel region 131 include event pixels 141 and gradation pixels 151. The event pixel 141 detects an event signal. The event signal is a signal indicating, as an event, a change in luminance of the incident light in the same direction. Note that a photodiode or a single photon avalanche diode (SPAD) may be provided as a photoelectric conversion section of the event pixel 141. The gradation pixel 151 detects a gradation signal. The gradation signal is a signal indicating a level according to the luminance of the incident light.

The light-shielded pixel region 132 may be disposed at an end portion of the effective pixel region 131. The light-shielded pixel region 132 may be disposed adjacent to the effective pixel region 131. The pixels arranged in the light-shielded pixel region 132 include a light-shielded event pixel 142 and a light-shielded gradation pixel 152. The light-shielded event pixel 142 is a pixel in which the event pixel 141 is shielded from light. The light-shielded event pixel 142 may be formed by disposing a light-shielding film on the event pixel 141. The light-shielded gradation pixel 152 is a pixel in which the gradation pixel 151 is shielded from light. The light-shielded gradation pixel 152 may be formed by disposing a light-shielding film on the gradation pixel 151. The light-shielded event pixels 142 and the light-shielded gradation pixels 152 may be arranged for each column or may be arranged for each row.

The event pixels 141, the gradation pixels 151, the light-shielded event pixels 142, and the light-shielded gradation pixels 152 may be driven row by row via a horizontal control line 182. The event pixels 141 and the light-shielded event pixels 142 may output signals for each column via a vertical event signal lines 162. The gradation pixel 151 and the light-shielded gradation pixel 152 can output a signal for each column via a vertical gradation signal line 172. Note that the vertical gradation signal line 172 is an example of a vertical signal line recited in the claims.

The event signal output section 113 outputs the event signal output from the event pixel 141 and the light-shielded pixel signal output from the light-shielded event pixel 142 in a predetermined format. For example, the event signal output section 113 may digitize and output the event signal output from the event pixel 141 and the light-shielded pixel signal output from the light-shielded event pixel 142.

The gradation signal output section 114 outputs the gradation signal output from the gradation pixel 151 and the light-shielded pixel signal output from the light-shielded gradation pixel 152 in a predetermined format. For example, the gradation signal output section 114 may digitize and output the gradation signal output from the gradation pixel 151 and the light-shielded pixel signal output from the light-shielded gradation pixel 152. Furthermore, the gradation signal output section 114 may also support constant current readout or may support capacitive load readout.

The access control section 115 controls access to the event pixel 141, the gradation pixel 151, the light-shielded event pixel 142, and the light-shielded gradation pixel 152 via the horizontal control line 182. At this time, the access control section 115 can drive the event pixel 141, the gradation pixel 151, the light-shielded event pixel 142, and the light-shielded gradation pixel 152 for each row via the horizontal control line 182.

The timing control section 116 can control timings such as exposure, reading, selection, and reset for the event pixel 141, the gradation pixel 151, the light-shielded event pixel 142, and the light-shielded gradation pixel 152.

The event signal processing section 117 processes the event signal output from the event pixel 141 and the light-shielded pixel signal output from the light-shielded event pixel 142. For example, the event signal processing section 117 may detect crosstalk with the event pixel 141 on the basis of the light-shielded pixel signal output from the light-shielded event pixel 142, and may detect a false event occurring in the event pixel 141.

The event signal processing section 117 includes a false event detection circuit 112. The false event detection circuit 112 detects a false event output from the event pixel 141 on the basis of the output from the light-shielded event pixel 142. The false event detection circuit 112 may detect a false event caused by crosstalk with the horizontal control line 182 used for the gradation pixel 151 on the basis of the output from the light-shielded event pixel 142. The false event detection circuit 112 may detect a false event due to crosstalk with the vertical gradation signal line 172 on the basis of the output from the light-shielded event pixel 142. Note that the false event detection circuit 112 is an example of a detection circuit recited in the claims.

The gradation signal processing section 118 processes the gradation signal and the light-shielded pixel signal output from the gradation signal output section 114. For example, the gradation signal processing section 118 may perform correlated double sampling (CDS) processing on the basis of the gradation signal output from the gradation signal output section 114.

The output interface 121 converts the output of the event signal processing section 117 so as to correspond to the data format of the output destination. The output interface 122 converts the output of the gradation signal processing section 118 so as to correspond to the data format of the output destination.

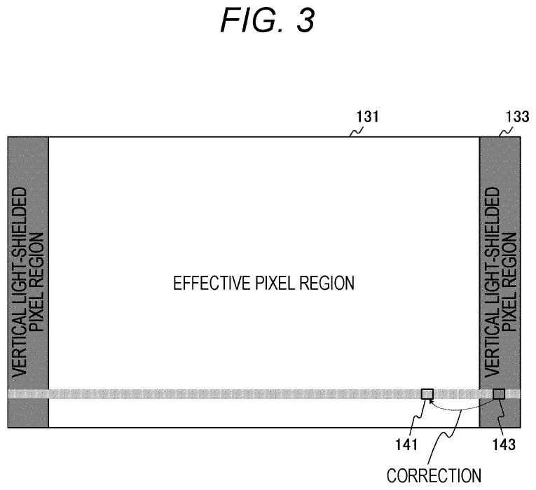

FIG. 3 is a block diagram illustrating a configuration example of the pixel array section according to the first embodiment.

In the drawing, vertical light-shielded pixel regions 133 are provided at both ends in the row direction of the effective pixel region 131. In the vertical light-shielded pixel region 133, a light-shielded event pixel 143 is disposed. The light-shielded event pixel 143 may be provided for each row. At this time, the false event detection circuit 112 may detect a false event output from the event pixels 141 arranged in the row direction on the basis of the output from the light-shielded event pixel 143. The false event may be due to crosstalk of the gradation pixels 151 with the horizontal control lines 182. The false event output from the event pixel 141 may be corrected so that the false event is not output. For example, the horizontal control line 182 of the gradation pixel 151 is disposed in the horizontal direction so as to be drivable for each row. For this reason, all the event pixels 141 in the horizontal direction close to the horizontal control line 182 of the row receive similar crosstalk, and a horizontal streak-like false event occurs. At this time, by providing the light-shielded event pixel 143 for each row, it is possible for the light-shielded event pixel 143 to detect a false event of the event pixel 141 that has occurred on the basis of the row drive of the horizontal control line 182.

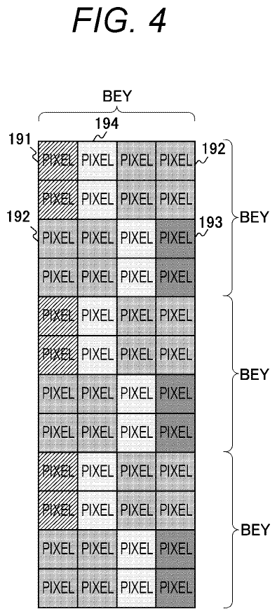

FIG. 4 is a block diagram illustrating an arrangement example of pixels of the pixel array section according to the first embodiment.

In the drawing, pixels may be arranged in a quad-Bayer array in the effective pixel region 131. At this time, the event pixels 141 and the gradation pixels 151 can be arranged in each quad-Bayer array BEY. In each quad-Bayer array BEY, the gradation pixel 151 includes two red pixels 191, two blue pixels 193, and eight green pixels 192. The event pixel 141 includes four event pixels 194.

In this quad-Bayer array BEY, four event pixels 194 are provided instead of the two red pixels 191 and the two blue pixels 193 in the quad-Bayer array including only the gradation pixels 151. Therefore, it is possible to mixedly mount the gradation pixels 151 and the event pixels 141 in the effective pixel region 131 while suppressing a decrease in sensitivity of the colored gradation image.

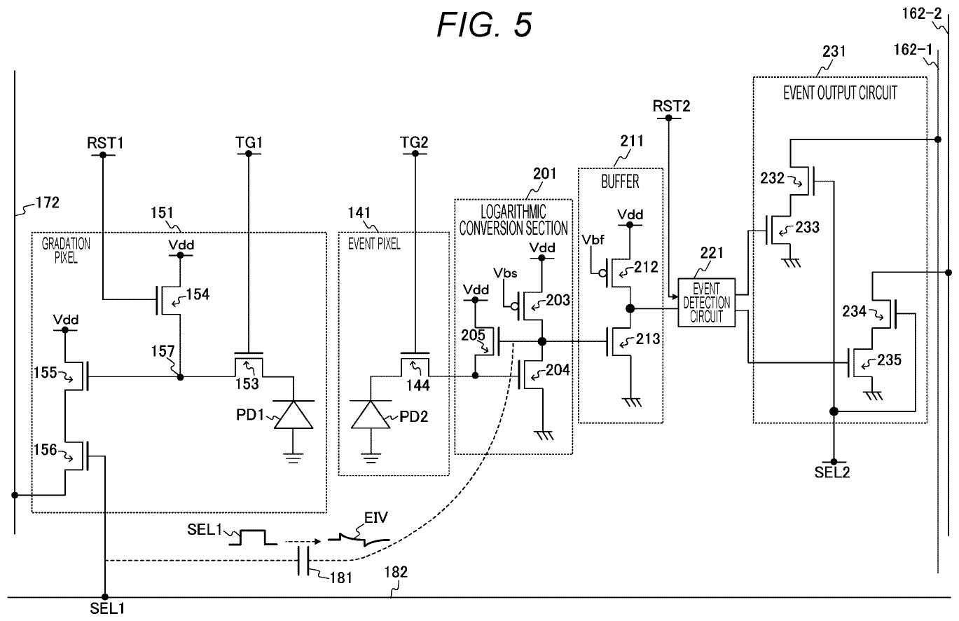

FIG. 5 is a circuit diagram illustrating an example of signal crosstalk between a gradation pixel and an event pixel of the solid-state imaging device according to the first embodiment. Note that the drawing illustrates a configuration example of the event pixel 141 for one pixel, the gradation pixel 151 for one pixel, and the event output circuit for one pixel.

In the drawing, the gradation pixel 151 includes a photodiode PD1, a transfer transistor 153, a reset transistor 154, an amplification transistor 155, a selection transistor 156, and a floating diffusion 157. A metal oxide semiconductor (MOS) transistor can be used as the transfer transistors 153, the reset transistor 154, the amplification transistor 155, and the selection transistor 156.

The amplification transistor 155 and the selection transistor 156 are connected in series. A cathode of the photodiode PD1 is connected to the floating diffusion 157 via the transfer transistor 153. Furthermore, the floating diffusion 157 is connected to a power supply Vdd via the reset transistor 154. Furthermore, the power supply Vdd is connected to the vertical gradation signal line 172 via a series circuit of the amplification transistor 155 and the selection transistor 156. A gate of the amplification transistor 155 is connected to the floating diffusion 157.

A transfer signal TG1 is applied to a gate of the transfer transistor 153. A reset signal RST1 is applied to a gate of the reset transistor 154. A selection signal SEL1 is applied to a gate of the selection transistor 156. The transfer signal TG1, the reset signal RST1, and the selection signal SEL1 can be transmitted to the gradation pixel 151 via the horizontal control line 182 in FIG. 2.

When the transfer transistor 153 is turned on, the charge accumulated in the photodiode PD1 is transferred to the floating diffusion 157. Then, when the selection transistor 156 is turned on, a source potential of the amplification transistor 155 changes according to a potential of the floating diffusion 157. Then, the source potential of the amplification transistor 155 is applied to the vertical gradation signal line 172 via the selection transistor 156 and transmitted via the vertical gradation signal line 172. Furthermore, when the reset transistor 154 is turned on, the charge accumulated in the floating diffusion 157 is discharged.

The event pixel 141 includes a photodiode PD2 and a transfer transistor 144. The photodiode PD2 is connected to the logarithmic conversion section 201 via the transfer transistor 144.

The event signal output section 113 includes a logarithmic conversion section 201, a buffer 211, an event detection circuit 221, and an event output circuit 231.

The logarithmic conversion section 201 logarithmically converts the event signal output from the event pixel 141. The logarithmic conversion section 201 is connected to the subsequent stage of the event pixel 141. The logarithmic conversion section 201 includes NMOS transistors 205 and 204, and a PMOS transistor 203. The PMOS transistor 203 and the NMOS transistor 204 are connected to each other in series. A connection point of the PMOS transistor 203 and the NMOS transistor 204 is used as an output of the logarithmic conversion section 201. Furthermore, the connection point of the PMOS transistor 203 and the NMOS transistor 204 is connected to a gate of the NMOS transistor 205. A bias voltage Vbs is applied to a gate of the PMOS transistor 203. A gate of the NMOS transistor 204 is connected to a source of the transfer transistor 144 and a source of the NMOS transistor 205. Furthermore, the power supply Vdd is supplied to drains of the PMOS transistor 203 and the NMOS transistor 205.

The buffer 211 passes the output of the logarithmic conversion section 201 to the event detection circuit 221. The buffer 211 is connected to a subsequent stage of the logarithmic conversion section 201. The buffer 211 includes a PMOS transistor 212 and an NMOS transistor 213. The PMOS transistor 212 and the NMOS transistor 213 are connected to each other in series. A connection point of the PMOS transistor 212 and the NMOS transistor 213 is used as an output of the buffer 211. A bias voltage Vbf is applied to a gate of the PMOS transistor 212. A gate of the NMOS transistor 213 is connected to the connection point of the PMOS transistor 203 and the NMOS transistor 204. The power supply Vdd is supplied to a drain of the PMOS transistor 212.

The event detection circuit 221 is connected to a subsequent stage of the buffer 211. The event detection circuit 221 detects an event on the basis of the output of the buffer 211. The event detection circuit 221 can detect a change in luminance of incident light as an event by for example setting the past level of a light reception signal as a reference level and obtaining a difference between the reference level and the current level of the light reception signal. At this time, the event detection circuit 221 may separately detect an event (positive electrode event) in which the luminance of the incident light increases and an event (negative electrode event) in which the luminance of the incident light decreases.

Here, the event detection circuit 221 resets the reference level to the current level of the light reception signal on the basis of a reset signal RST2. The reset signal RST2 is input to the event detection circuit 221 via the horizontal control line 182. The event detection circuit 221 can newly detect an event on the basis of a change in the light reception signal level from the time point at which the reference level is reset.

The event output circuit 231 outputs the event detected by the event detection circuit 221 as a change in an increasing direction of the luminance of the incident light and a change in a decreasing direction of the luminance of the incident light. At this time, as the vertical event signal lines 162, vertical event signal lines 162-1 and 162-2 are provided for each column. The event output circuit 231 is connected to a subsequent stage of the event detection circuit 221. The event output circuit 231 includes NMOS transistors 232 to 235. The NMOS transistors 232 and 233 are connected to each other in series. The NMOS transistors 234 and 235 are connected to each other in series. A selection signal SEL2 is input to gates of the NMOS transistors 232 and 234. The detection result of the positive electrode event is input to a gate of the NMOS transistor 233 from the event detection circuit 221. The detection result of the negative electrode event is input to a gate of the NMOS transistor 235 from the event detection circuit 221. A drain of the NMOS transistor 232 is connected to the vertical event signal line 162-1. A drain of the NMOS transistor 234 is connected to the vertical event signal line 162-2.

When the transfer transistor 144 is turned on, the charge accumulated in the photodiode PD2 is transferred to the logarithmic conversion section 201. Then, the event signal output from the event pixel 141 is subjected to logarithmic conversion on the basis of the source follower operation in the logarithmic conversion section 201, and is input to the event detection circuit 221 via the buffer 211. Then, in the event detection circuit 221, a positive electrode event and a negative electrode event are detected and input to the gates of the NMOS transistors 233 and 235. Then, when the selection signal SEL2 is applied to the gates of the NMOS transistors 232 and 234, the positive event is output to the vertical event signal line 162-1 and the negative event is output to the vertical event signal line 162-2.

Here, for example, the horizontal control line 182 and the gate of the NMOS transistor 205 of the logarithmic conversion section 201 are coupled via a parasitic capacitance 181. This coupling effect increases along with miniaturization of the gradation pixels 151 and the event pixels 141. Here, when the selection signal SEL1 is transmitted to the gradation pixel 151 via the horizontal control line 182 while the event signal is not output from the event pixel 141, a false event signal EIV is input to the logarithmic conversion section 201. Then, when the false event signal EIV is input to an event detection circuit 221 via a buffer 211, the false event signal EIV is detected as an event signal, and a false event is output from the event detection circuit 221.

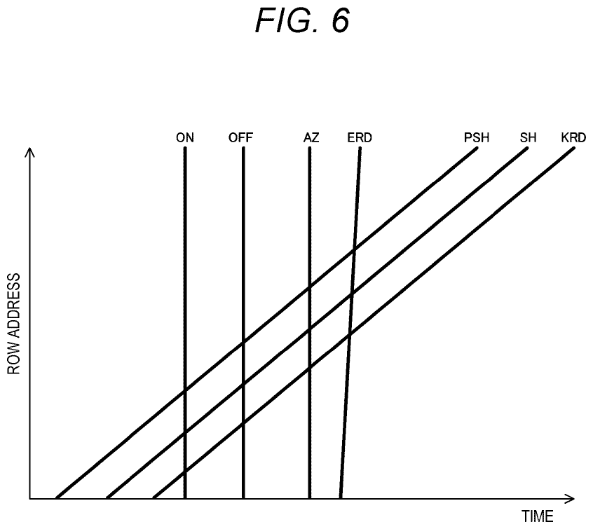

FIG. 6 is a diagram illustrating an example of a timing of signal crosstalk between the gradation pixel and the event pixel of the solid-state imaging device according to the first embodiment. Note that the horizontal axis in the drawing represents time, and the vertical axis represents row address. Furthermore, the drawing illustrates an example in which a gradation signal of a frame period in which gradation signals of all rows of the pixel array section 111 are generated and an event signal is generated in the period.

In the drawing, in the generation of the gradation signal, the preshutter PSH, the shutter SH, and the lead KRD for the gradation pixel 151 are performed for each frame. Furthermore, in the generation of the event signal, the positive electrode event detection ON, the negative electrode event detection OFF, the reset AZ, and the lead ERD for the event pixel 141 are performed for each frame

At this time, if the timing of the positive electrode event detection ON coincides with the timing of any of the preshutter PSH, the shutter SH, and the lead KRD of the gradation pixel 151, and crosstalk occurs between these signals, a false event may occur. Furthermore, if the timing of the negative electrode event detection OFF coincides with the timing of any of the preshutter PSH, the shutter SH, and the read KRD of the gradation pixel 151, and crosstalk occurs between these signals, a false event may occur.

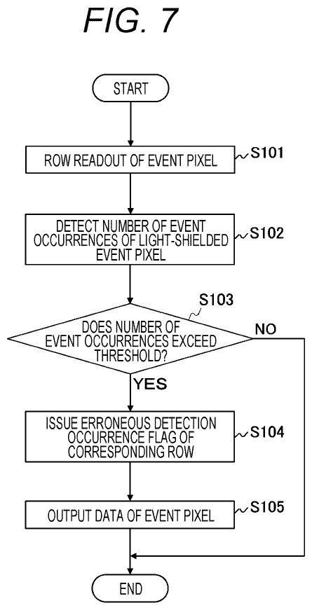

FIG. 7 is a flowchart illustrating an example of false event detection processing by the solid-state imaging device according to the first embodiment.

In the drawing, the event signal processing section 117 reads the event signal from the event pixel 141 for each row, and reads the light-shielded pixel signal of the row from the light-shielded event pixel 142 (S101).

Next, the event signal processing section 117 detects the number of event occurrences in the light-shielded event pixel 142 on the basis of the light-shielded pixel signal read from the light-shielded event pixel 142 (S102). Note that, in the light-shielded event pixel 142, an event may be detected due to crosstalk based on the operation of the gradation pixel 151. The event detected at the light-shielded event pixel 142 is detected as a false event at the event pixel 141.

Next, the event signal processing section 117 determines whether the number of event occurrences detected in the light-shielded event pixel 142 exceeds a threshold (S103). In a case where the number of event occurrences detected by the light-shielded event pixel 142 exceeds the threshold, the event signal processing section 117 issues an erroneous detection occurrence flag of the corresponding row (S104).

Next, the event signal processing section 117 outputs the data of the event pixel 141 (S105), and ends the processing. On the other hand, in a case where the number of event occurrences detected in the light-shielded event pixel 142 does not exceed the threshold in S103, the event signal processing section 117 ends the process.

As described above, in the first embodiment described above, the false event output from the event pixel 141 is detected on the basis of the output from the light-shielded event pixel 142. Therefore, it is possible to improve the detection accuracy of the event signal while enabling the gradation pixels 151 and the event pixels 141 to be mixedly mounted.

For example, the false event caused by the crosstalk of the horizontal control line 182 of the gradation pixel 151 occurs similarly in both the effective pixel region 131 and the light-shielded pixel region 132. Therefore, by detecting the number of event occurrences in the light-shielded pixel region 132, a false event can be effectively detected.

Furthermore, the false event detection circuit 112 does not need to specify the timing at which crosstalk occurs at the time of design in order to detect a false event occurring in the event pixel 141. Therefore, the false event detection circuit 112 can also detect a false event due to crosstalk that is not assumed at the time of design, a false event due to crosstalk that occurs in a specific imaging scene, and a false event that occurs in a specific sample due to sample variation.

### 2. Second Embodiment

In the first embodiment described above, the false event output from the event pixel 141 is detected on the basis of the output from the light-shielded event pixel 142. In a second embodiment, a false event output from an event pixel 141 is detected on the basis of the output from a light-shielded event pixel 142, and the detection result is notified.

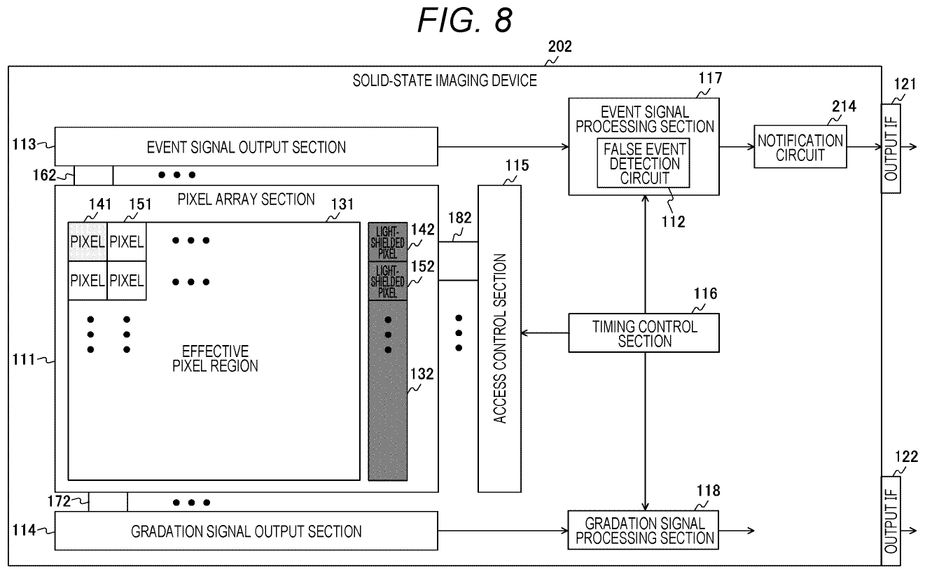

FIG. 8 is a block diagram illustrating a configuration example of a solid-state imaging device according to the second embodiment.

In the drawing, in a solid-state imaging device 202, a notification circuit 214 is added to the solid-state imaging device 102 of the first embodiment described above. Other configurations of the solid-state imaging device 202 of the second embodiment are similar to the configurations of the solid-state imaging device 102 of the first embodiment described above.

The notification circuit 214 outputs the false event detected by a false event detection circuit 112 to the outside via an output interface 121. The notification circuit 214 is connected to a subsequent stage of an event signal processing section 117. At this time, the notification circuit 214 may add information regarding the false event detected by the false event detection circuit 112 to the output data of an event image. For example, the notification circuit 214 may add the information regarding the false event detected by the false event detection circuit 112 to the data of the event output frame or may add the information to essential bit data (EBD). The information regarding the false event may be a false detection occurrence flag.

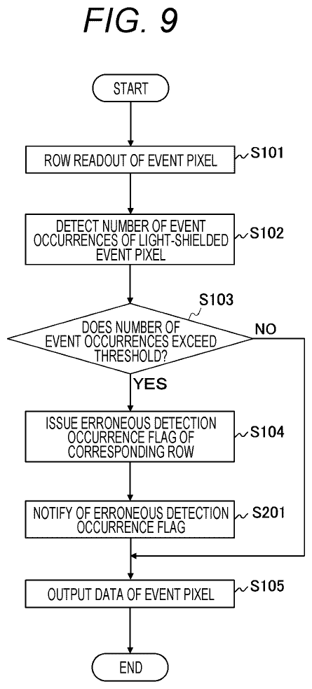

FIG. 9 is a flowchart illustrating an example of false event detection processing of the solid-state imaging device according to the second embodiment.

In the drawing, in this flow, processing of S201 is added to the flow of the first embodiment described above. Other than that, the flow of the second embodiment is similar to the flow of the first embodiment described above.

When the erroneous detection occurrence flag of the row in which the false event has occurred is issued, the notification circuit 214 notifies of the erroneous detection occurrence flag via the output interface 121 (S201), and advances the processing to S105.

As described above, in the second embodiment described above, the false event output from the event pixel 141 is detected on the basis of the output from the light-shielded event pixel 142, and the detection result is notified. Therefore, it is possible to perform correction of a false event externally while enabling mixed mounting of gradation pixels 151 and the event pixels 141, and it is possible to reduce a load applied to the solid-state imaging device 202.

### 3. Third Embodiment

In the first embodiment described above, the false event output from the event pixel 141 is detected on the basis of the output from the light-shielded event pixel 142. In the third embodiment, a false event output from an event pixel 141 is detected on the basis of the output from a light-shielded event pixel 142, and the false event is corrected.

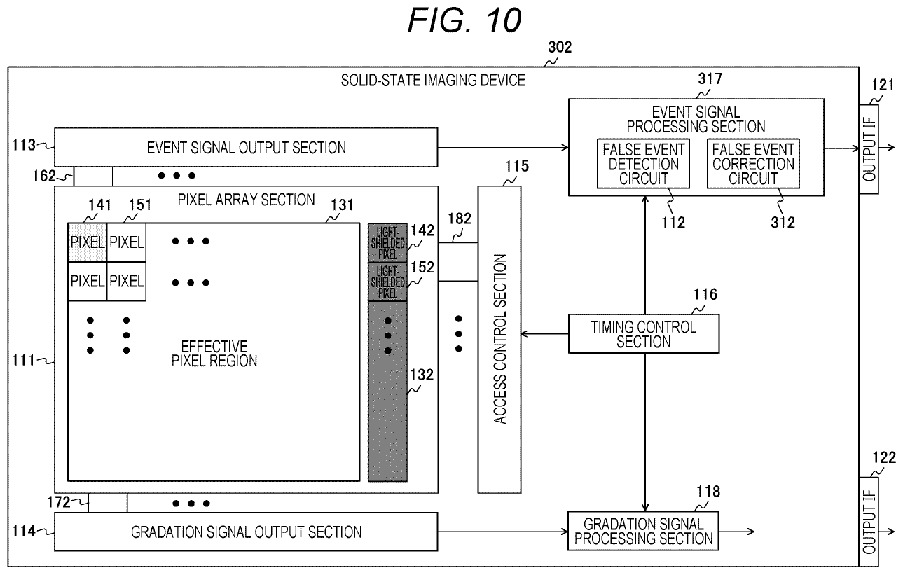

FIG. 10 is a block diagram illustrating a configuration example of a solid-state imaging device according to the third embodiment.

In the drawing, a solid-state imaging device 302 includes an event signal processing section 317 instead of the event signal processing section 117 of the first embodiment described above. Other configurations of the solid-state imaging device 302 of the third embodiment are similar to the configurations of the solid-state imaging device 102 of the first embodiment described above.

In the event signal processing section 317, a false event correction circuit 312 is added to the event signal processing section 117 of the first embodiment described above. The other configurations of the event signal processing section 317 of the third embodiment are similar to the configurations of the event signal processing section 117 of the first embodiment described above.

The false event correction circuit 312 corrects the false event detected at the event pixel 141 on the basis of a false event detected at a false event detection circuit 112. The false event correction circuit 312 may mask a false event detected at the event pixels 141 on the basis of a false event detected at the false event detection circuit 112. The false event correction circuit 312 may mask a false event detected at the event pixels 141 on the basis of a false event detected at the false event detection circuit 112. The false event correction circuit 312 may interpolate events detected at the event pixels 141 on the basis of a false event detected at the false event detection circuit 112. For this interpolation, an event signal detected at an event pixel 141 in the vicinity of an event pixel 141 where a false event is detected may be used. The false event correction circuit 312 may spatially or temporally filter the event signal detected at the event pixel 141 on the basis of a false event detected at the false event detection circuit 112.

As described above, in the third embodiment described above, the false event output from the event pixel 141 is detected on the basis of the output from the light-shielded event pixel 142, and the false event is corrected. Therefore, it is possible to correct a false event while allowing gradation pixels 151 and the event pixels 141 to be mixedly mounted. At this time, by spatially or temporally filtering the false event detected in the event pixel 141, it is possible to suppress the influence of the correction on an event image.

### 4. Fourth Embodiment

In the first embodiment described above, the vertical light-shielded pixel regions 133 are provided at both ends in the row direction of the effective pixel region 131. In the fourth embodiment, horizontal light-shielded pixel regions are provided at both ends in the column direction of an effective pixel region.

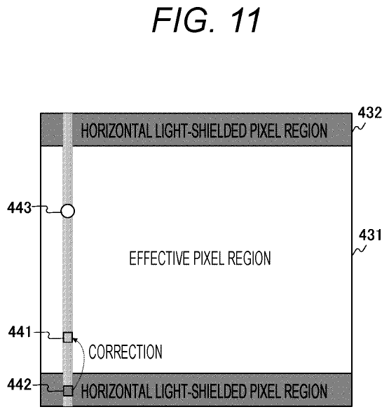

FIG. 11 is a block diagram illustrating a configuration example of a pixel array section according to the fourth embodiment.

In the drawing, the pixel array section includes an effective pixel region 431 and a horizontal light-shielded pixel region 432 instead of the effective pixel region 131 and the vertical light-shielded pixel region 133 of the first embodiment described above. Other configurations of the pixel array section of the fourth embodiment are similar to the configurations of the pixel array section of the first embodiment described above.

The horizontal light-shielded pixel regions 432 are provided at both ends in the column direction of the effective pixel region 431. In the effective pixel region 431, an event pixel 441 is disposed. In the horizontal light-shielded pixel region 432, a light-shielded event pixel 442 is disposed. The light-shielded event pixels 442 may be provided for each column. At this time, a false event detection circuit 112 may detect a false event output from the event pixels 441 arranged in the column direction on the basis of the output from the light-shielded event pixels 442. The false event may be due to crosstalk of gradation pixels 151 with a vertical gradation signal line 172. The false event output from the event pixel 441 may be corrected so that the false event is not output. For example, the vertical gradation signal lines 172 of the gradation pixels 151 are arranged in the vertical direction so that signals can be read out for each column. Since the output signal of the gradation pixel 151 depends on the light intensity received by the photodiode PD1 of the gradation pixel 151, crosstalk proportional to the light intensity occurs. In a case where crosstalk occurs on the basis of light reception 443 of the gradation pixel 151 of a certain light intensity or higher, a false event may occur in the event pixel 441. At this time, since all the event pixels 441 arranged in the vertical direction close to the vertical gradation signal line 172 are affected by the crosstalk, the false event occurs in a vertical stripe manner. Here, by providing the light-shielded event pixel 442 for each column, the light-shielded event pixel 442 can detect a false event of the event pixel 441 that has occurred on the basis of driving of the vertical gradation signal line 172 for each column.

Other configurations of the effective pixel region 431 and the horizontal light-shielded pixel region 432 of the fourth embodiment are similar to the configurations of the effective pixel region 131 and the vertical light-shielded pixel region 133 of the first embodiment described above.

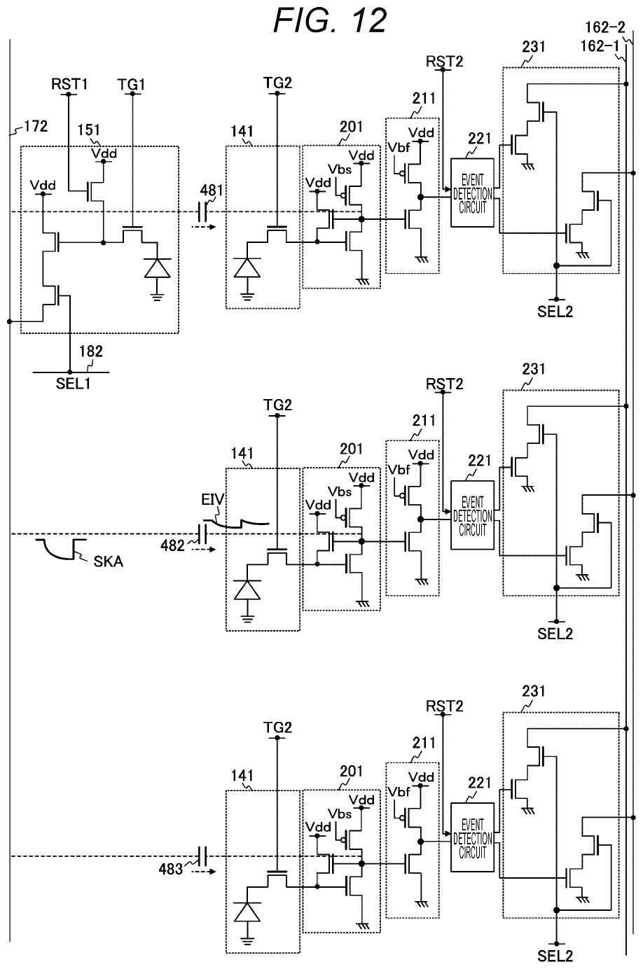

FIG. 12 is a circuit diagram illustrating an example of signal crosstalk between the gradation pixel and the event pixel of the solid-state imaging device according to the fourth embodiment.

In the drawing, for example, the vertical gradation signal line 172 and the NMOS transistor 205 of the logarithmic conversion section 201 of each column are coupled for each column via parasitic capacitances 481 to 483. This coupling effect increases along with miniaturization of the gradation pixels 151 and the event pixels 141. Here, when a gradation signal SKA is transmitted via the vertical gradation signal line 172 while no event signal is output from the event pixel 141, a false event signal EIV is input to the logarithmic conversion section 201. Then, when the false event signal EIV is input to an event detection circuit 221 via a buffer 211, the false event signal EIV is detected as an event signal, and a false event is output from the event detection circuit 221. At this time, as illustrated in FIG. 11, the false event detection circuit 112 can detect a false event output from the event pixel 442 on the basis of the output from the light-shielded event pixel 441 provided in the horizontal light-shielded pixel region 432.

As described above, in the above-described fourth embodiment, the false event output from the event pixel 441 is detected on the basis of the output from the light-shielded event pixel 442 provided in the horizontal light-shielded pixel region 432. Therefore, it is possible to improve the detection accuracy of the event signal while enabling the gradation pixels 151 and the event pixels 141 to be mixedly mounted.

For example, the false event caused by the crosstalk of the vertical gradation signal line 172 of the gradation pixel 151 occurs similarly in both the effective pixel region 431 and the horizontal light-shielded pixel region 432. Therefore, by detecting the number of event occurrences in the horizontal light-shielded pixel region 432, a false event can be effectively detected.

### 5. Fifth Embodiment

In the above-described fourth embodiment, the false event output from the event pixel 441 is detected on the basis of the output from the light-shielded event pixel 442 provided in the horizontal light-shielded pixel region 432. In the fifth embodiment, a false event output from an event pixel is detected on the basis of an output from a light-shielded event pixel provided in a vertical light-shielded pixel region and an output from a light-shielded event pixel provided in a horizontal light-shielded pixel region.

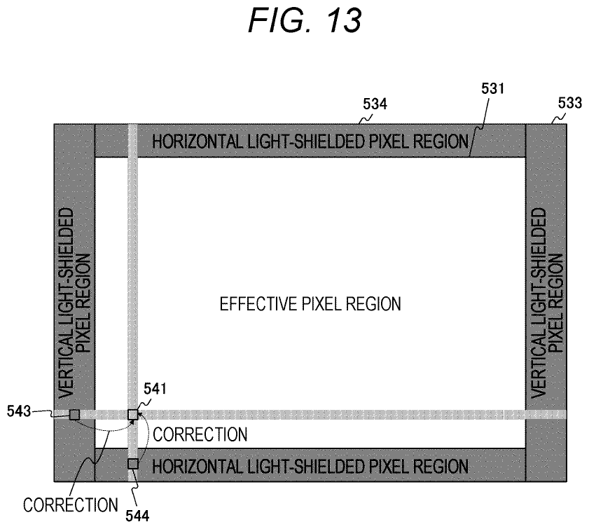

FIG. 13 is a block diagram illustrating a configuration example of a pixel array section according to the fifth embodiment.

In the drawing, the pixel array section includes an effective pixel region 531, a vertical light-shielded pixel region 533, and a horizontal light-shielded pixel region 534 instead of the effective pixel region 131 and the vertical light-shielded pixel region 133 of the first embodiment described above. Other configurations of the pixel array section of the fifth embodiment are similar to the configurations of the pixel array section of the first embodiment described above.

The vertical light-shielded pixel regions 533 are provided at both ends in the row direction of the effective pixel region 531. In the effective pixel region 531, an event pixel 541 is disposed. In the vertical light-shielded pixel region 533, a light-shielded event pixel 543 is disposed. The light-shielded event pixel 543 may be provided for each row. At this time, a false event detection circuit 112 may detect a false event output from the event pixels 541 arranged in the row direction on the basis of the output from the light-shielded event pixel 543. The false event output from the event pixel 541 may be corrected so that the false event is not output.

The horizontal light-shielded pixel regions 534 are provided at both ends in the column direction of the effective pixel region 531. In the horizontal light-shielded pixel region 534, a light-shielded event pixel 544 is disposed. The light-shielded event pixel 544 may be provided for each column. At this time, the false event detection circuit 112 may detect a false event output from the event pixels 541 arranged in the column direction on the basis of the output from the light-shielded event pixel 544. The false event output from the event pixel 541 may be corrected so that the false event is not output.

Other configurations of the effective pixel region 531 and the vertical light-shielded pixel region 533 of the fifth embodiment are similar to the configurations of the effective pixel region 131 and the vertical light-shielded pixel region 133 of the first embodiment described above. Other configurations of the horizontal light-shielded pixel region 534 of the fifth embodiment are similar to the configurations of the horizontal light-shielded pixel region 432 of the fourth embodiment described above.

As described above, in the above-described fifth embodiment, the false event output from the event pixel 541 is detected on the basis of the output from the light-shielded event pixel 543 in the vertical light-shielded pixel region 533 and the output from the light-shielded event pixel 544 in the horizontal light-shielded pixel region 534. Therefore, it is possible to detect false events uniformly occurring in the row direction and the column direction while enabling mixed mounting of the gradation pixels 151 and the event pixels 541.

### 6. Sixth Embodiment

In the first embodiment described above, the light-shielded event pixels 142 are arranged outside the effective pixel region 131. In the sixth embodiment, light-shielded event pixels are arranged in an effective pixel region.

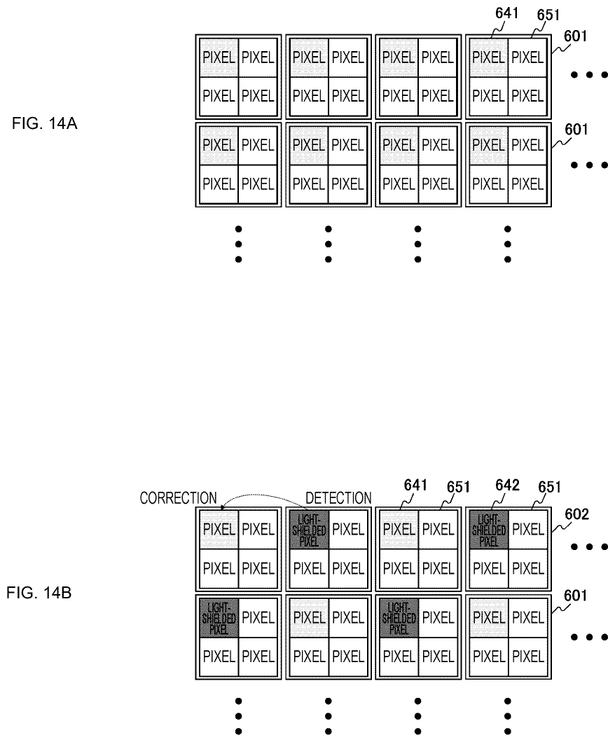

FIG. 14 is a block diagram illustrating a configuration example of a pixel array section according to the sixth embodiment. Note that a in the drawing illustrates an arrangement example of event pixels 641 and gradation pixels 651 when light-shielded event pixels are arranged outside an effective pixel region. In the drawing, b illustrates an arrangement example of the event pixels 641 and the gradation pixels 651 when the light-shielded event pixels 642 are arranged in the effective pixel region.

In a of the drawing, the pixel array section includes a cell 601 including a plurality of pixels as an array unit. The cells 601 are arranged in a matrix in the row direction and the column direction in the effective pixel region. In each cell 601, for example, pixels can be arranged in units of 2×2. Each cell 601 may include one event pixel 641 and three gradation pixels 651.

In b of the drawing, the pixel array section includes cells 601 and 602 including a plurality of pixels as arrangement units. The cells 601 and 602 are arranged in a matrix in the row direction and the column direction in the effective pixel region. In each of the cells 601 and 602, for example, pixels can be arranged in units of 2×2. Each cell 601 may include one event pixel 641 and three gradation pixels 651. Each cell 602 may include one light-shielded event pixel 642 and three gradation pixels 651.

The cells 601 and 602 may be arranged in a matrix in the row direction and the column direction in arrangement units of 2×2. Here, in the 2×2 arrangement units, the cells 601 may be arranged in one diagonal direction and the cells 602 may be arranged in the other diagonal direction. At this time, the event pixels 641 of each cell 601 in a of the drawing is replaced with light-shielded event pixels 642 in every other row direction and column direction. Here, a false event detection circuit 112 may detect a false event output from the event pixel 641 in the vicinity of the light-shielded event pixel 642 on the basis of the output from the light-shielded event pixel 642.

As described above, in the above-described sixth embodiment, the light-shielded event pixels 642 are arranged in the effective pixel region. Therefore, the light-shielded event pixels 642 can be arranged in the vicinity of the event pixels 641. As a result, a false event similar to the false event occurring in the event pixel 641 can occur in the light-shielded event pixel 642, and the detection accuracy of the event signal can be improved.

Furthermore, the false event detection circuit 112 can detect a locally generated false event by arranging the light-shielded event pixels 642 in the effective pixel region. For example, the false event detection circuit 112 may detect a false event due to local power drop when high brightness light is locally incident.

### 7. Seventh Embodiment

In the first embodiment described above, the event pixels 141 and the gradation pixels 151 are arranged in the quad-Bayer array BEY. In the seventh embodiment, event pixels, gradation pixels, and light-shielded event pixels are arranged in a quad-Bayer array BEY.

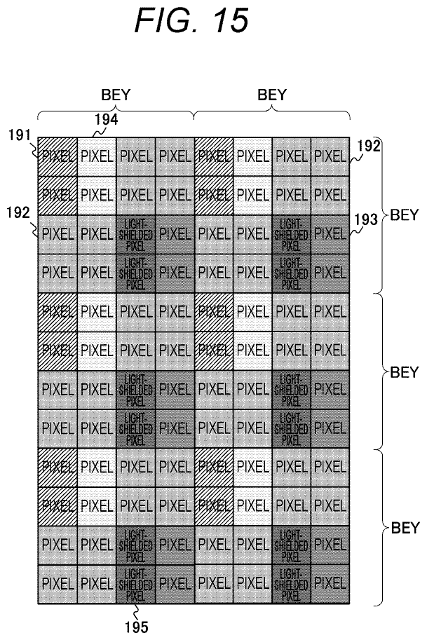

FIG. 15 is a block diagram illustrating an arrangement example of a pixel array section according to the seventh embodiment.

In the drawing, a quad-Bayer array BEY is provided in the effective pixel region. In the quad-Bayer array BEY, an event pixel 141, a gradation pixel 151, and a light-shielded event pixel 142 may be arranged. In each quad-Bayer array BEY, the gradation pixel 151 includes two red pixels 191, two blue pixels 193, and eight green pixels 192. The event pixel 141 includes two event pixels 194. The light-shielded event pixel 142 includes two light-shielded event pixels 195. At this time, a false event detection circuit 112 may detect a false event output from the event pixel 194 in the vicinity of the light-shielded event pixel 195 on the basis of the output from the light-shielded event pixel 195.

In the quad-Bayer array BEY, the two light-shielded event pixels 195 are provided instead of the two blue pixels 193 in the quad-Bayer array BEY of the first embodiment described above. Therefore, the event pixel 141, the gradation pixel 151, and the light-shielded event pixel 142 can be mixedly mounted in the effective pixel region while suppressing a decrease in sensitivity of a colored gradation image.

As such, in the seventh embodiment described above, each quad-Bayer array BEY includes the two red pixels 191, the two blue pixels 193, the eight green pixels 192, the two event pixels 194, and the two light-shielded event pixels 195. Therefore, it is possible to arrange the light-shielded event pixel 195 in the vicinity of the event pixel 194 while suppressing a decrease in sensitivity of the colored gradation image.

### 8. Eighth Embodiment

In the first embodiment described above, the false event output from the event pixel 141 is detected on the basis of the output from the light-shielded event pixel 142. In the eighth embodiment, a pixel array section is stacked, a light receiving section of each pixel is provided in an upper layer, and a circuit section is provided in a lower layer.

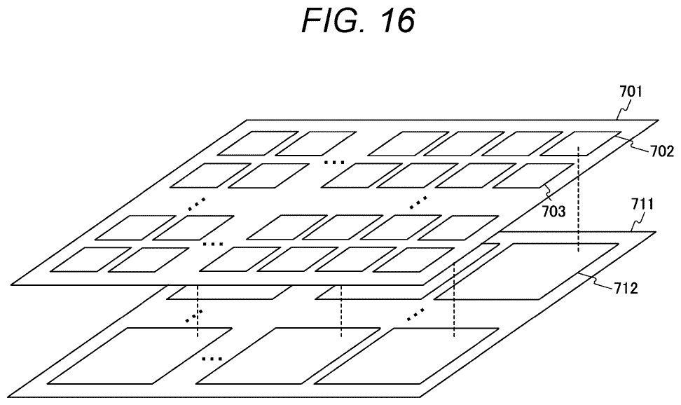

FIG. 16 is a perspective view illustrating a configuration example of pixels of the pixel array section according to the eighth embodiment.

In the drawing, the pixel array section includes a light receiving array section 701 and a circuit array section 711. The light receiving array section 701 can be stacked on the circuit array section 711. The light receiving array section 701 includes light receiving sections 702 and 703. The light receiving sections 702 and 703 are arranged in a matrix in the row direction and the column direction. The light receiving section 702 can be provided with an event pixel 141 and a logarithmic conversion section 201. The light receiving section 703 can be provided with a gradation pixel 151.

The arrangement of the light receiving sections 702 and 703 may use the quad-Bayer array BEY in FIG. 5 or the array of the cells 601 in a in FIG. 14. Note that a part of the light receiving section 702 may be shielded from light. The light-shielded light receiving section 702 can be used as a light-shielded event pixel 142. In the configuration in which a part of the light receiving section 702 is shielded from light and used as the light-shielded event pixel 142, the quad-Bayer array BEY in FIG. 15 may be used, or the array of the cells 601 and 602 in b of FIG. 14 may be used.

The circuit array section 711 includes circuit sections 712. The circuit sections 712 are arranged in a matrix in the row direction and the column direction. The circuit section 712 is connected to the light receiving section 702. The circuit section 712 can be provided for each light receiving section 702. At this time, the circuit section 712 can be disposed immediately below the light receiving section 702. The circuit section 712 may be disposed to protrude immediately below the light receiving section 703 according to the circuit scale. The circuit section 712 can be provided with the buffer 211, the event detection circuit 221, and the event output circuit 231 of FIG. 5.

The light receiving array section 701 can be formed in an upper layer chip, and the circuit array section 711 can be formed in a lower layer chip. At this time, the upper layer chip and the lower layer chip may be directly bonded to each other.

In the direct bonding of the upper layer chip and the lower layer chip, hybrid bonding can be used. At this time, the upper layer chip and the lower layer chip may be electrically connected to each other on the basis of Cu-Cu connection. A material of semiconductor substrates used for the upper layer chip and the lower layer chip may be Si, InGaAs, or InP.

As described above, in the above-described eighth embodiment, the light receiving array section 701 and the circuit array section 711 are stacked. Therefore, it is possible to increase an area of the light receiving sections 702 and 703 while suppressing an increase in chip size, and it is possible to improve sensitivity while downsizing the solid-state imaging device.

### 9. Application Example to Mobile Body

The technology according to the present disclosure (present technology) can be applied to various kinds of products. For example, the technology according to the present disclosure may be implemented as a device to be mounted on a mobile body of any kind, such as an automobile, an electric automobile, a hybrid electric automobile, a motorcycle, a bicycle, a personal mobility, an airplane, a drone, a ship, or a robot.

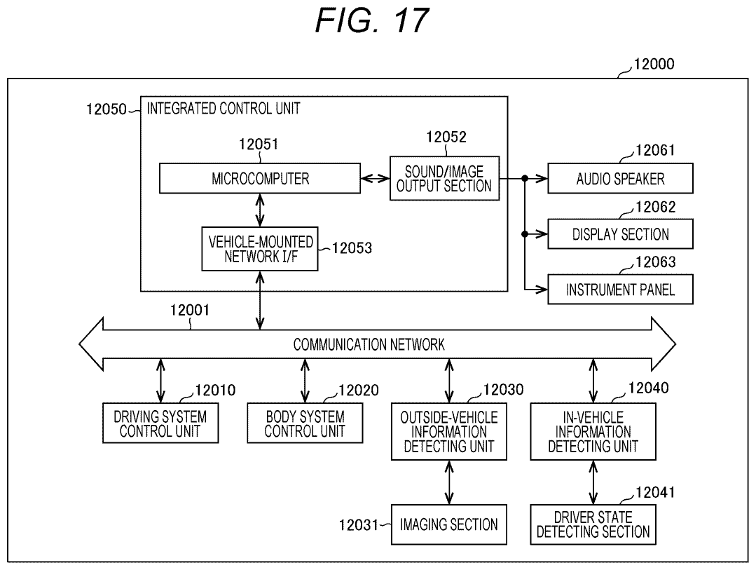

FIG. 17 is a block diagram illustrating a schematic configuration example of a vehicle control system as an example of a mobile body control system to which the technology according to the present disclosure can be applied.

The vehicle control system 12000 includes a plurality of electronic control units connected to each other via a communication network 12001. In the example illustrated in FIG. 17, the vehicle control system 12000 includes a driving system control unit 12010, a body system control unit 12020, an outside-vehicle information detecting unit 12030, an in-vehicle information detecting unit 12040, and an integrated control unit 12050. Furthermore, a microcomputer 12051, a sound/image output section 12052, and a vehicle-mounted network interface (I/F) 12053 are illustrated as functional components of the integrated control unit 12050.

The driving system control unit 12010 controls the operation of devices related to the driving system of the vehicle in accordance with various kinds of programs. For example, the driving system control unit 12010 functions as a control device for a driving force generating device for generating the driving force of the vehicle, such as an internal combustion engine, a driving motor, or the like, a driving force transmitting mechanism for transmitting the driving force to wheels, a steering mechanism for adjusting the steering angle of the vehicle, a braking device for generating the braking force of the vehicle, and the like.

The body system control unit 12020 controls the operation of various kinds of devices provided to a vehicle body in accordance with various kinds of programs. For example, the body system control unit 12020 functions as a control device for a keyless entry system, a smart key system, a power window device, or various kinds of lamps such as a headlamp, a backup lamp, a brake lamp, a turn signal, a fog lamp, or the like. In this case, radio waves transmitted from a mobile device as an alternative to a key or signals of various kinds of switches can be input to the body system control unit 12020. The body system control unit 12020 receives these input radio waves or signals, and controls a door lock device, the power window device, the lamps, or the like of the vehicle.

The outside-vehicle information detecting unit 12030 detects information about the outside of the vehicle including the vehicle control system 12000. For example, the outside-vehicle information detecting unit 12030 is connected with an imaging section 12031. The outside-vehicle information detecting unit 12030 makes the imaging section 12031 image an image of the outside of the vehicle, and receives the imaged image. On the basis of the received image, the outside-vehicle information detecting unit 12030 may perform processing of detecting an object such as a human, a vehicle, an obstacle, a sign, a character on a road surface, or the like, or processing of detecting a distance thereto.

The imaging section 12031 is an optical sensor that receives light, and which outputs an electric signal corresponding to a received light amount of the light. The imaging section 12031 can output the electric signal as an image, or can output the electric signal as information about a measured distance. Furthermore, the light received by the imaging section 12031 may be visible light, or may be invisible light such as infrared rays.

The in-vehicle information detecting unit 12040 detects information about the inside of the vehicle. The in-vehicle information detecting unit 12040 is, for example, connected with a driver state detecting section 12041 that detects the state of a driver. The driver state detecting section 12041, for example, includes a camera that images the driver. On the basis of detection information input from the driver state detecting section 12041, the in-vehicle information detecting unit 12040 may calculate a degree of fatigue of the driver or a degree of concentration of the driver, or may determine whether the driver is dozing.

The microcomputer 12051 can calculate a control target value for the driving force generating device, the steering mechanism, or the braking device on the basis of the information about the inside or outside of the vehicle which information is obtained by the outside-vehicle information detecting unit 12030 or the in-vehicle information detecting unit 12040, and output a control command to the driving system control unit 12010. For example, the microcomputer 12051 can perform cooperative control intended to implement functions of an advanced driver assistance system (ADAS) which functions include collision avoidance or shock mitigation for the vehicle, following driving based on a following distance, vehicle speed maintaining driving, a warning of collision of the vehicle, a warning of deviation of the vehicle from a lane, or the like.

In addition, the microcomputer 12051 can perform cooperative control intended for automated driving, which makes the vehicle to travel automatedly without depending on the operation of the driver, or the like, by controlling the driving force generating device, the steering mechanism, the braking device, or the like on the basis of the information about the outside or inside of the vehicle which information is obtained by the outside-vehicle information detecting unit 12030 or the in-vehicle information detecting unit 12040.

Furthermore, the microcomputer 12051 can output a control command to the body system control unit 12020 on the basis of the information about the outside of the vehicle acquired by the outside-vehicle information detecting unit 12030. For example, the microcomputer 12051 can perform cooperative control intended to prevent a glare by controlling the headlamp so as to change from a high beam to a low beam, for example, in accordance with the position of a preceding vehicle or an oncoming vehicle detected by the outside-vehicle information detecting unit 12030.

The sound/image output section 12052 transmits an output signal of at least one of a sound and an image to an output device capable of visually or auditorily notifying information to an occupant of the vehicle or the outside of the vehicle. In the example in FIG. 17, as the output device, an audio speaker 12061, a display section 12062, and an instrument panel 12063 are illustrated. The display section 12062 may, for example, include at least one of an on-board display and a head-up display.

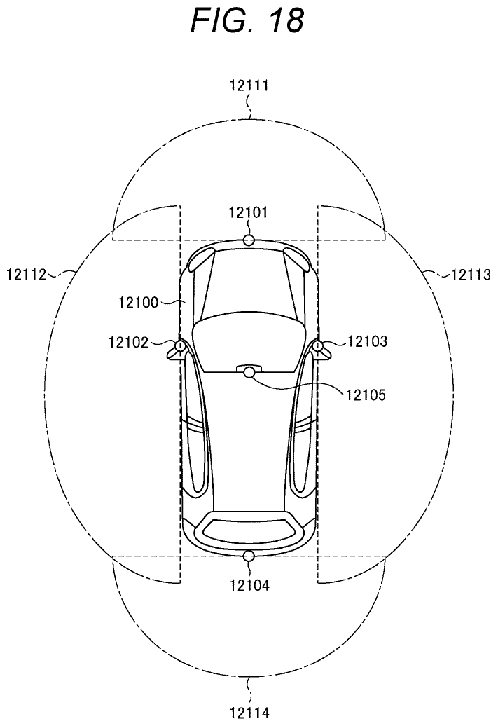

FIG. 18 is a diagram illustrating an example of the installation position of the imaging section 12031.

In FIG. 18, the imaging section 12031 includes imaging sections 12101, 12102, 12103, 12104, and 12105.

The imaging sections 12101, 12102, 12103, 12104, and 12105 are provided at positions, for example, the front nose, the sideview mirrors, the rear bumper, the back door, an upper portion of the windshield in the interior, and the like of the vehicle 12100. The imaging section 12101 provided to the front nose and the imaging section 12105 provided to the upper portion of the windshield within the interior of the vehicle obtain mainly an image of the front of the vehicle 12100. The imaging sections 12102 and 12103 provided to the sideview mirrors obtain mainly images of the sides of the vehicle 12100. The imaging section 12104 provided to the rear bumper or the back door obtains mainly an image of the rear of the vehicle 12100. The imaging section 12105 provided to the upper portion of the windshield within the interior of the vehicle is used mainly to detect a preceding vehicle, a pedestrian, an obstacle, a signal, a traffic sign, a lane, or the like.

Note that FIG. 18 illustrates examples of imaging ranges of the imaging sections 12101 to 12104. An imaging range 12111 represents the imaging range of the imaging section 12101 provided to the front nose. Imaging ranges 12112 and 12113 respectively represent the imaging ranges of the imaging sections 12102 and 12103 provided to the sideview mirrors. An imaging range 12114 represents the imaging range of the imaging section 12104 provided to the rear bumper or the back door. A bird's-eye image of the vehicle 12100 as viewed from above is obtained by superimposing image data imaged by the imaging sections 12101 to 12104, for example.

At least one of the imaging sections 12101 to 12104 may have a function of obtaining distance information. For example, at least one of the imaging sections 12101 to 12104 may be a stereo camera constituted of a plurality of imaging elements, or may be an imaging element having pixels for phase difference detection.

For example, the microcomputer 12051 can determine a distance to each three-dimensional object within the imaging ranges 12111 to 12114 and a temporal change in the distance (relative speed with respect to the vehicle 12100) on the basis of the distance information obtained from the imaging sections 12101 to 12104, and thereby extract, as a preceding vehicle, a nearest three-dimensional object in particular that is present on a traveling path of the vehicle 12100 and which travels in substantially the same direction as the vehicle 12100 at a predetermined speed (for example, equal to or more than 0 km/hour). Further, the microcomputer 12051 can set a following distance to be maintained in front of a preceding vehicle in advance, and perform automatic brake control (including following stop control), automatic acceleration control (including following start control), or the like. It is thus possible to perform cooperative control intended for automated driving that makes the vehicle travel automatedly without depending on the operation of the driver or the like.

For example, the microcomputer 12051 can classify three-dimensional object data on three-dimensional objects into three-dimensional object data of a two-wheeled vehicle, a standard-sized vehicle, a large-sized vehicle, a pedestrian, a utility pole, and other three-dimensional objects on the basis of the distance information obtained from the imaging sections 12101 to 12104, extract the classified three-dimensional object data, and use the extracted three-dimensional object data for automatic avoidance of an obstacle. For example, the microcomputer 12051 identifies obstacles around the vehicle 12100 as obstacles that the driver of the vehicle 12100 can recognize visually and obstacles that are difficult for the driver of the vehicle 12100 to recognize visually. Then, the microcomputer 12051 determines a collision risk indicating a risk of collision with each obstacle. In a situation in which the collision risk is equal to or higher than a set value and there is thus a possibility of collision, the microcomputer 12051 outputs a warning to the driver via the audio speaker 12061 or the display section 12062, and performs forced deceleration or avoidance steering via the driving system control unit 12010. The microcomputer 12051 can thereby assist in driving to avoid collision.

At least one of the imaging sections 12101 to 12104 may be an infrared camera that detects infrared rays. The microcomputer 12051 can, for example, recognize a pedestrian by determining whether or not there is a pedestrian in imaged images of the imaging sections 12101 to 12104. Such recognition of a pedestrian is, for example, performed by a procedure of extracting characteristic points in the imaged images of the imaging sections 12101 to 12104 as infrared cameras and a procedure of determining whether or not it is the pedestrian by performing pattern matching processing on a series of characteristic points representing the contour of the object. When the microcomputer 12051 determines that there is a pedestrian in the imaged images of the imaging sections 12101 to 12104, and thus recognizes the pedestrian, the sound/image output section 12052 controls the display section 12062 so that a square contour line for emphasis is displayed so as to be superimposed on the recognized pedestrian. The sound/image output section 12052 may also control the display section 12062 so that an icon or the like representing the pedestrian is displayed at a desired position.

An example of the vehicle control system to which the technology according to the present disclosure can be applied has been described above. The technology of the present disclosure can be applied to the imaging section 12031 among the configurations described above. Specifically, for example, the solid-state imaging device 102 of the present disclosure can be applied to the imaging section 12031. By applying the technology according to the present disclosure to the vehicle control system 12000, it is possible to improve the detection accuracy of an event while enabling mixed mounting of gradation pixels and event pixels.

Note that the embodiments described above indicate examples for embodying the present technology, and the respective matters in the embodiments and the respective matters specifying the invention in the claims have correspondence relationships. Similarly, the respective matters specifying the invention in the claims and the respective matters with the same names in the embodiments of the present technology have correspondence relationships. The present technology, however, is not limited to the embodiments, and can be implemented by making various modifications to the embodiments without departing from the scope of the present technology. Furthermore, effects described in the present specification are merely examples and not limited, and other effects may be provided.

Note that the present technology may also have the following configurations.

(1) A photodetection device including:
a gradation pixel that detects a gradation signal;
an event pixel that detects an event signal;
a light-shielded event pixel in which the event pixel is shielded from light; and
a detection circuit that detects a false event output from the event pixel on the basis of an output from the light-shielded event pixel.

(2) The photodetection device according to (1) described above, further including
a correction circuit that corrects a false event detected by the detection circuit.

(3) The photodetection device according to (2) described above, in which
the correction circuit masks the event signal detected in the event pixel on the basis of a false event detected by the detection circuit.

(4) The photodetection device according to (2) or (3) described above, in which
the correction circuit interpolates the event signal detected in the event pixel with the event signal detected in an event pixel near the event pixel on the basis of a false event detected by the detection circuit.

(5) The photodetection device according to any one of (2) to (4) described above, in which
the correction circuit spatially or temporally filters the event signal detected in the event pixel on the basis of a false event detected by the detection circuit.

(6) The photodetection device according to any one of (1) to (5) described above, further including
a notification circuit that notifies of a false event detected by the detection circuit.

(7) The photodetection device according to (6) described above, in which
the notification circuit adds information regarding a false event detected by the detection circuit to output data of an event image.

(8) The photodetection device according to any one of (1) to (7) described above, including
an effective pixel region in which pixels are arranged in a row direction and a column direction including the gradation pixel and the event pixel.

(9) The photodetection device according to (8) described above, in which
the gradation pixels are arranged in the effective pixel region on the basis of a quad-Bayer array, and
the event pixels are arranged at positions of two red pixels out of four red pixels and positions of two blue pixels out of four blue pixels in the quad-Bayer array.

(10) The photodetection device according to (8) or (9) described above, in which
the light-shielded event pixel is disposed at an end portion of the effective pixel region in the row direction.

(11) The photodetection device according to (10) described above, in which
the detection circuit detects a false event output from the event pixels arranged in the row direction on the basis of an output from the light-shielded event pixel.

(12) The photodetection device according to (11) described above, in which
the detection circuit detects a false event caused by crosstalk with a horizontal control line of the gradation pixel on the basis of an output from the light-shielded event pixel.

(13) The photodetection device according to any one of (8) to (12) described above, in which
the light-shielded event pixel is disposed at an end portion of the effective pixel region in the column direction.

(14) The photodetection device according to (13) described above, in which
the detection circuit detects a false event output from the event pixels arranged in the column direction on the basis of an output from the light-shielded event pixel.

(15) The photodetection device according to (14) described above, in which
the detection circuit detects a false event caused by crosstalk with a vertical signal line of the gradation pixel on the basis of an output from the light-shielded event pixel.

(16) The photodetection device according to any one of (8) to (15) described above, in which
the light-shielded event pixel is disposed in the effective pixel region.

(17) The photodetection device according to (16) described above, in which
the detection circuit detects a false event output from an event pixel near the light-shielded event pixel on the basis of an output from the light-shielded event pixel.

(18) An imaging device including:
an effective pixel region in which pixels are arranged in a row direction and a column direction including a gradation pixel that detects a gradation signal and an event pixel that detects an event signal; and
a light-shielded event pixel that is provided in the effective pixel region and in which the event pixel is shielded from light.

(19) The imaging device of (18) described above, in which
the gradation pixels are arranged in the effective pixel region on the basis of a quad-Bayer array,
the event pixels are arranged at positions of two red pixels out of four red pixels in the quad-Bayer array, and
the light-shielded event pixels are arranged at positions of two blue pixels out of four blue pixels in the quad-Bayer array.

(20) Electronic equipment including:
a photodetection device including
a gradation pixel that detects a gradation signal,
an event pixel that detects an event signal,
a light-shielded event pixel in which the event pixel is shielded from light, and
a detection circuit that detects a false event output from the event pixel on the basis of an output from the light-shielded event pixel; and
a processing section that processes the event signal on the basis of the false event detected by the detection circuit.

### REFERENCE SIGNS LIST

100 Imaging device
101 Optical system
102 Solid-state imaging device
103 Imaging control section
104 Image processing section
105 Storage section
106 Display section
107 Operation section
108 Bus
111 Pixel array section
112 False event detection circuit
113 Event signal output section
114 Gradation signal output section
115 Access control section
116 Timing control section
117 Event signal processing section
118 Gradation signal processing section
121, 122 Output interface
131 Effective pixel region
132 Light-shielded pixel region
141 Event pixel
142 Light-shielded event pixel
151 Gradation pixel
152 Light-shielded gradation pixel
162 Vertical event signal line
172 Vertical gradation signal line
182 Horizontal control line

1. A photodetection device comprising:
a gradation pixel that detects a gradation signal;
an event pixel that detects an event signal;
a light-shielded event pixel in which the event pixel is shielded from light; and
a detection circuit that detects a false event output from the event pixel on a basis of an output from the light-shielded event pixel.

2. The photodetection device according to claim 1, further comprising
a correction circuit that corrects a false event detected by the detection circuit.

3. The photodetection device according to claim 2, wherein
the correction circuit masks the event signal detected in the event pixel on a basis of a false event detected by the detection circuit.

4. The photodetection device according to claim 2, wherein
the correction circuit interpolates the event signal detected in the event pixel with the event signal detected in an event pixel near the event pixel on a basis of a false event detected by the detection circuit.

5. The photodetection device according to claim 2, wherein
the correction circuit spatially or temporally filters the event signal detected in the event pixel on a basis of a false event detected by the detection circuit.

6. The photodetection device according to claim 1, further comprising
a notification circuit that notifies of a false event detected by the detection circuit.

7. The photodetection device according to claim 6, wherein
the notification circuit adds information regarding a false event detected by the detection circuit to output data of an event image.

8. The photodetection device according to claim 1, further comprising
an effective pixel region in which pixels are arranged in a row direction and a column direction including the gradation pixel and the event pixel.

9. The photodetection device according to claim 8, wherein
the gradation pixels are arranged in the effective pixel region on a basis of a quad-Bayer array, and
the event pixels are arranged at positions of two red pixels out of four red pixels and positions of two blue pixels out of four blue pixels in the quad-Bayer array.

10. The photodetection device according to claim 8, wherein
the light-shielded event pixel is disposed at an end portion of the effective pixel region in the row direction.

11. The photodetection device according to claim 8, wherein
the detection circuit detects a false event output from the event pixels arranged in the row direction on a basis of an output from the light-shielded event pixel.

12. The photodetection device according to claim 8, wherein
the detection circuit detects a false event caused by crosstalk with a horizontal control line of the gradation pixel on a basis of an output from the light-shielded event pixel.

13. The photodetection device according to claim 8, wherein
the light-shielded event pixel is disposed at an end portion of the effective pixel region in the column direction.

14. The photodetection device according to claim 8, wherein
the detection circuit detects a false event output from the event pixels arranged in the column direction on a basis of an output from the light-shielded event pixel.

15. The photodetection device according to claim 8, wherein
the detection circuit detects a false event caused by crosstalk with a vertical signal line of the gradation pixel on a basis of an output from the light-shielded event pixel.

16. The photodetection device according to claim 8, wherein
the light-shielded event pixel is disposed in the effective pixel region.

17. The photodetection device according to claim 16, wherein
the detection circuit detects a false event output from an event pixel near the light-shielded event pixel on a basis of an output from the light-shielded event pixel.

18. An imaging device comprising:
an effective pixel region in which pixels are arranged in a row direction and a column direction including a gradation pixel that detects a gradation signal and an event pixel that detects an event signal; and
a light-shielded event pixel that is provided in the effective pixel region and in which the event pixel is shielded from light.

19. The imaging device of claim 18, wherein
the gradation pixels are arranged in the effective pixel region on a basis of a quad-Bayer array,
the event pixels are arranged at positions of two red pixels out of four red pixels in the quad-Bayer array, and
the light-shielded event pixels are arranged at positions of two blue pixels out of four blue pixels in the quad-Bayer array.

20. Electronic equipment comprising:
a photodetection device including
a gradation pixel that detects a gradation signal,
an event pixel that detects an event signal,
a light-shielded event pixel in which the event pixel is shielded from light, and
a detection circuit that detects a false event output from the event pixel on a basis of an output from the light-shielded event pixel; and
a processing section that processes the event signal on a basis of the false event detected by the detection circuit.
